(19) United States
(12) Patent Application Publication
(10) Pub. No.: US 2010/0195157 A1
(43) Pub. Date: Aug. 5, 2010

(54) IMAGE FORMING APPARATUS AND IMAGE FORMING METHOD OF THE IMAGE FORMING APPARATUS

(75) Inventor: Katsuya SASAHARA, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/699,570

(22) Filed: Feb. 3, 2010

Related U.S. Application Data
(60) Provisional application No. 61/150,250, filed on Feb. 5, 2009.

(51) Int. Cl. G06K 15/00; G08B 13/14; B41F 13/56

(52) U.S. Cl. 358/1.18; 340/572.1; 270/20.1

(57) ABSTRACT

An image forming apparatus includes a stack tray moving mechanism to move a stack tray in a paper ejection direction of a recording medium by a specified length each time the recording medium folded by a sheet finisher is ejected, prints a fold line identifier on a surface of the recording medium which becomes an upper surface when the recording medium is folded and ejected, along a folded fold line, and at a position where, when the recording medium is stacked on the stack tray, the fold line identifier is not hidden by a subsequently ejected recording medium, and performs folding and paper ejection. Image formation of printed content is performed on the recording medium which is located inside when folding is performed.

### CROSS-REFERENCE TO RELATED APPLICATIONS

This application is based upon and claims the benefit of priority from the prior U.S. Patent Application No. 61/150,250, filed on 5 Feb. 2009, the entire contents of which are incorporated herein by reference.

### TECHNICAL FIELD

The present invention relates to an image forming apparatus such as a copying machine, and particularly to an image forming apparatus in which security can be simply raised.

### BACKGROUND

An image forming apparatus such as a copying machine is often used by plural persons. However, there is a case where the printed content is desired not to be seen by another person. That is, there is a request to ensure such simple security that the printed content is not seen by another person.

In this point, for example, JP-A-2001-322337 discloses a technique in which plural trays are provided in a sheet finisher, a printing person is enabled to confirm that a printed recording medium is ejected onto which tray, and the sheet finisher sorts sheets to corresponding trays and ejects them.

However, in this technique, it is necessary that the number of trays is equal to the number of printing persons, and there is a problem that the number of printing persons who can share the image forming apparatus is limited.

Besides, for example, JP-A-2004-284750 discloses a technique of performing dual page printing so that the printed content is on the inside.

However, in this technique, there is a problem that it can not be easily confirmed who is a printing person.

### SUMMARY

It is an object of the present invention to provide an image forming apparatus and an image forming method of the image forming apparatus, in which security can be simply raised.

In an aspect of the present invention, an image forming apparatus includes

a folding unit to fold a recording medium subjected to image formation,

a stack tray moving mechanism to move a stack tray, on which the folded recording medium is stacked, in a paper ejection direction by a specified length, and

an identifier printing portion to print a fold line identifier on a surface of the recording medium which becomes an upper surface when the recording medium is folded and is ejected, along a folded fold line, and at a position where, when the recording medium is stacked on the stack tray, the fold line identifier is not hidden by a subsequently ejected recording medium.

### DESCRIPTION OF THE DRAWINGS

FIG. 1 is a side sectional view showing an image forming apparatus.

FIG. 2 is a block diagram showing a control system of the image forming apparatus and a sheet finisher.

FIG. 3 is a view showing an example of an identifier printed on the back surface of a recording medium by an identifier printing portion of the image forming apparatus.

FIG. 4 is a view showing an example of a state in which the image forming apparatus performs folding and paper ejection.

FIG. 5 is a view showing an example of a booklet which becomes an original document.

FIG. 6 is a view showing a method using normal printing.

FIG. 7 is a view showing a printing method using magazine sort.

FIG. 8 is a view showing an example of an instruction screen displayed on a control panel of the image forming apparatus.

FIG. 9 is a flowchart showing an operation of the image forming apparatus.

### DETAILED DESCRIPTION

Throughout this description, the embodiments and examples shown should be considered as exemplars, rather than limitations on the apparatus and methods of the present invention.

Hereinafter, an embodiment of an image forming apparatus of the present invention will be described in detail by use of the drawings.

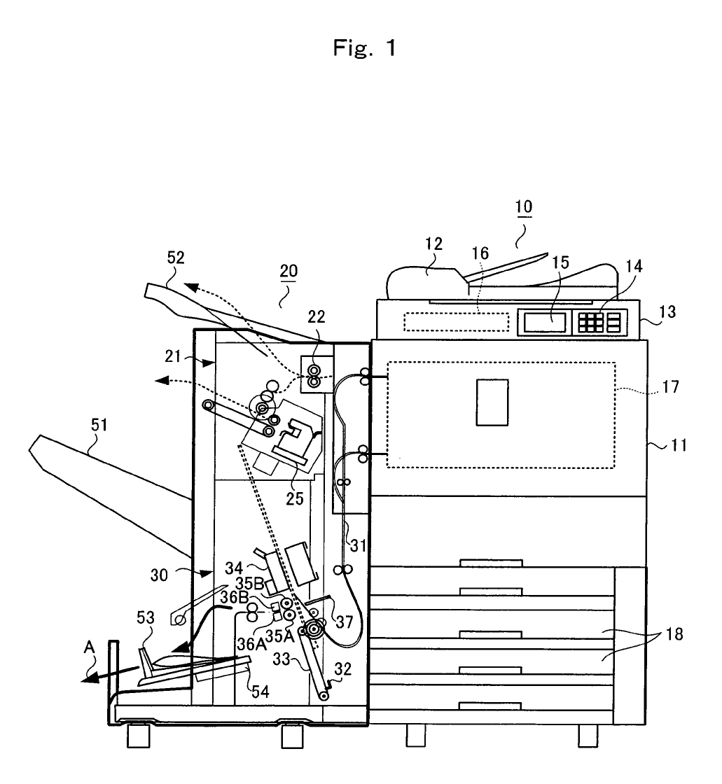

FIG. 1 is a side sectional view showing an image forming apparatus 10 of this embodiment. As shown in FIG. 1, a sheet finisher 20 is installed to be adjacent to an image forming apparatus 10 such as a copying machine, an MFP (Multifunction Peripheral) or a printer.

The image forming apparatus 10 includes an auto document feeder to feed a document one by one, a scan unit 16 to read this document, and a sheet cassette 18 to store a recording medium. Further, the image forming apparatus 10 includes a main body portion 11 to house an image forming portion 17 which forms an image on a recording medium conveyed one by one from the sheet cassette 18, and a control portion 13 including a control panel 15 and an operation button 14. The image forming apparatus 10 delivers the recording medium subjected to image formation to the sheet finisher 20.

The sheet finisher 20 includes a staple mechanism 21 to perform stapling and a folding unit 30 to perform folding.

The staple mechanism 21 includes a stapler 25 to staple the recording medium conveyed by a conveyance roller 22.

When neither stapling nor folding is performed, the recording medium is ejected to an upper storage tray 52. The stapled recording medium is ejected to a middle movable storage tray 51.

The folding unit 30 includes a conveyance mechanism 31 to convey a recording medium, a vertical alignment device 32 to temporarily stack the conveyed recording medium and to align it in a vertical direction, and a moving device 33 to convey the aligned recording medium to a staple position or a folding position.

The folding unit 30 further includes a stapler 34 and a folding mechanism. The folding mechanism includes a folding drive roller 35A and a folding driven roller 35B, which are a pair of folding rollers to fold a recording medium, a folding blade 37 to push the recording medium into a nip part between the folding drive roller 35A and the folding driven roller 35B, and a reinforcing unit 36 to further reinforce the folded recording medium.

The reinforcing unit 36 includes a lower reinforcing roller 36A and an upper reinforcing roller 36B, which are a pair of reinforcing rollers.

The folding roller has a rotation axis in a vertical direction to a sheet conveyance direction. The reinforcing roller has a rotation axis parallel to the sheet conveyance direction.

The reinforcing unit 36 nips a fold line of the folded recording medium by the lower reinforcing roller 36A and the upper reinforcing roller 36B, moves along the rotation axis of the folding roller and reinforces the fold line.

When stapling is performed, the recording medium is first conveyed to the staple position, and is stapled by the staple mechanism 21. Next, the stapled recording medium is folded by the folding unit 30.

The folded recording medium is ejected onto a stack tray 53. The stack tray 53 includes a stack tray moving mechanism 54 at a lower part. Each time the folded recording medium is ejected, the stack tray moving mechanism 54 moves the stack tray 53 by a specified length in a direction of an arrow A, that is, in a direction in which the recording medium is ejected. Accordingly, the folded recording medium is shifted by the specified length and is stacked on the stack tray 53.

The sheet finisher 20 may include an up and down direction alignment device to shift the recording medium ejected onto the stack tray 53 in an up and down direction for each print job, that is, in a far side or near side direction when viewed from an operator and to eject it.

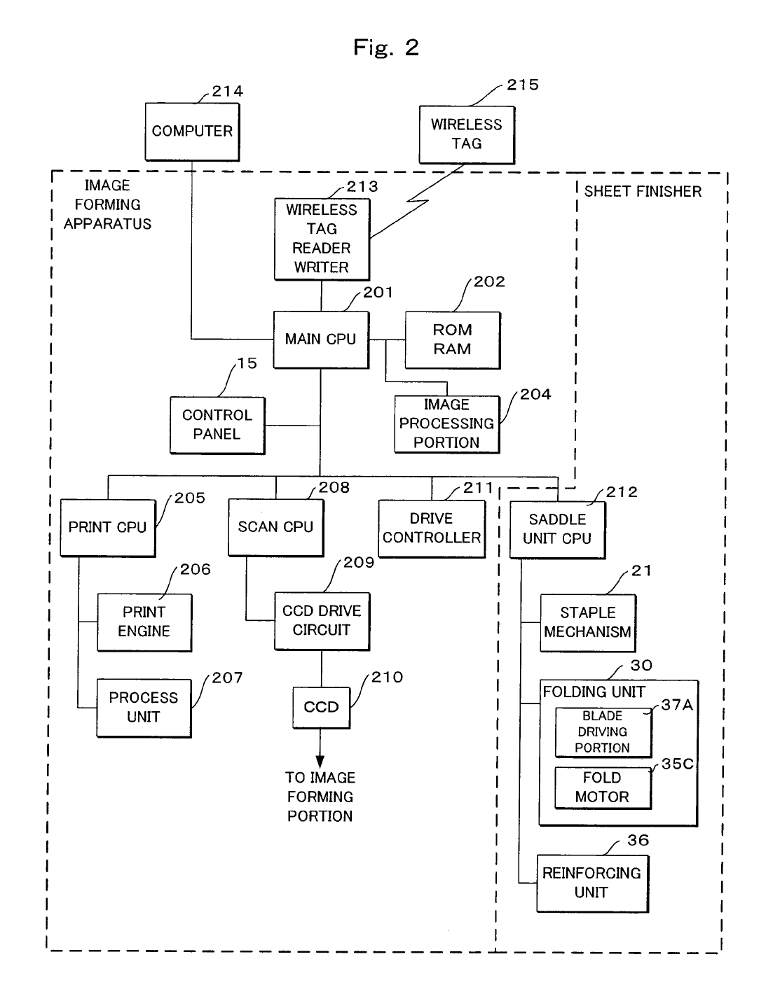

FIG. 2 is a block diagram showing a control system of the image forming apparatus 10 and the sheet finisher 20. As shown in FIG. 2, the image forming apparatus 10 includes a main CPU 201 to control the whole image forming apparatus 10, the control panel 15 connected to the main CPU 201, a memory 202, such as a ROM or a RAM, as a storage device, an image processing portion 204 to perform image processing, a print CPU 205 to control printing, a scan CPU 208 to control the scan unit 16, a drive controller 211 to control a conveyance roller of a recording medium, a saddle unit CPU 212 as a control portion to control the sheet finisher 20, and a wireless tag reader writer 213 to read and write a wireless tag 215.

The main CPU 201 is connected to a computer 214 such as a personal computer or a server through an interface.

The print CPU 205 controls a print engine 206 to perform image formation, and a process unit 207 to fix a recording medium subjected to image formation.

The scan CPU 208 controls a CCD drive circuit 209 to drive a CCD (Charge Coupled Device) 210.

The saddle unit CPU 212 controls the staple mechanism 21, the folding unit 30 and the reinforcing unit 36. The folding unit 30 includes a folding blade driving portion 37A to drive the folding blade 37 and a fold motor 35C to drive the folding drive roller 35A.

The image forming apparatus 10 includes an identifier printing portion to control layout of printed content to a recording medium, to control printing of an identifier and to control folding. The identifier printing portion includes the main CPU 201 and the saddle unit CPU 212.

The wireless tag 215 stores, for example, a user name, a user ID, information relating to an after-mentioned identifier, and the like. The wireless tag reader writer 213 communicates with the wireless tag 215, reads the user name, the user ID, and the information relating to the identifier, and transmits them to the main CPU 201.

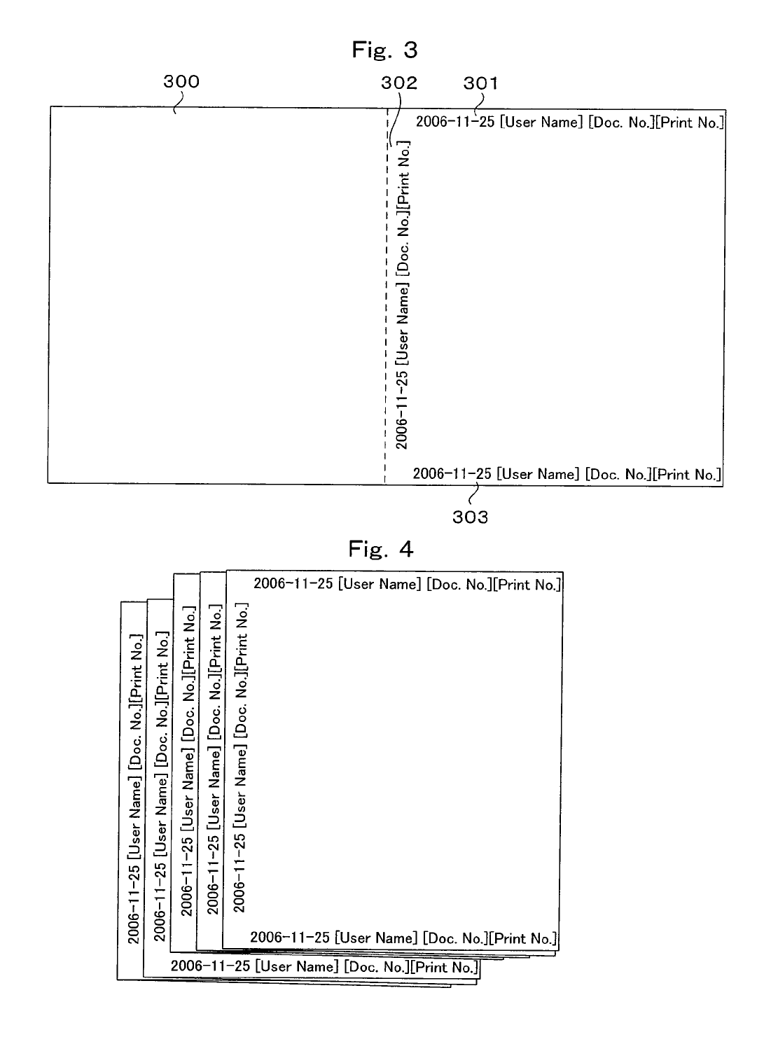

FIG. 3 is a view showing an example of the identifier printed on the back surface of a recording medium 300 by the identifier printing portion of the image forming apparatus 10. As shown in FIG. 3, the image forming apparatus 10 prints an upper identifier 301, a fold line identifier 302, and a lower identifier 303 on a surface of the recording medium 300 which becomes the upper surface when it is folded and ejected. The content of a print document is not printed on the surface on which the upper identifier 301, the fold line identifier 302 and the lower identifier 303 are printed.

Hereinafter, the upper identifier 301, the fold line identifier 302 and the lower identifier 303 are collectively called the identifier.

The image forming apparatus 10 prints the fold line identifier 302 along the folding fold line at a position where, when the recording medium is stacked on the stack tray 53, the fold line identifier is not hidden by a subsequently ejected recording medium 300.

The image forming apparatus 10 prints the lower identifier 303 along a side parallel to the conveyance direction of the recording medium 300 at a position where the lower identifier 303 is seen when a subsequently ejected recording medium 300 is ejected while being shifted in an upper direction, and prints the upper identifier 301 at a position where the upper identifier 301 is seen when a subsequently ejected recording medium 300 is ejected while being shifted in a lower direction.

Although each of the upper identifier 301, the fold line identifier 302 and the lower identifier 303 includes a print date, a user name, a document number, a print number and the like, no limitation is made to these.

Hereinafter, it is called simple security paper ejection or simply called simple security that as stated above, the print document is not printed on the surface which becomes the outermost side when folding is performed, but the upper identifier 301, the fold line identifier 302 and the lower identifier 303 are printed and the recording medium subjected to image formation is folded and ejected.

When the simple security paper ejection is selected, and when image formation of printed content of one sheet is performed on plural sheets, the image forming apparatus 10 prints the identifier only on the recording medium which is located most outside when folding is performed, and the plural recording media subjected to the image formation are collectively folded.

When the simple security paper ejection is selected, and when image formation of printed content is performed on one side of only one sheet, the image forming apparatus performs the image formation of the printed content on a surface which becomes the inside when folding is performed, prints the identifier on a surface which becomes the outside when folding is performed, and performs folding.

FIG. 4 is a view showing an example of a state in which the image forming apparatus 10 of the embodiment performs folding and paper ejection. As shown in FIG. 4, each of folded and formed booklets is shifted by a specified length and is stacked. Since the fold line identifier 302 is printed along the fold line at the position where it can be visually recognized when the booklet is stacked, it is easily understood which booklet belongs to which printing person.

Besides, as shown in FIG. 4, when a subsequently ejected booklet is shifted upward and is ejected in a subject print job, the lower identifier 303 can be visually recognized.

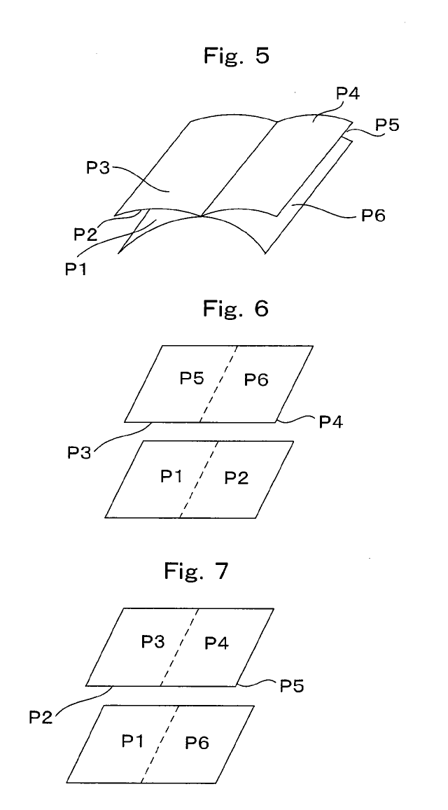

FIG. 5 is a view showing an example of a booklet which is an original document. As shown in FIG. 5, for example, it is assumed that the booklet in which P1 to P6 are printed from the left is read and is printed.

FIG. 6 is a view showing a method using normal printing. As shown in FIG. 6, P1 and P2 are printed on the first sheet, P3 and P4 are printed on the back surface of the second sheet, and P5 and P6 are printed on the front surface of the second sheet.

FIG. 7 is a view showing a printing method using magazine sort. As shown in FIG. 7, P1 and P6 are allocated and printed on the first sheet, P2 and P5 are allocated and printed on the back surface of the second sheet, and P3 and P4 are allocated and printed on the front surface of the second sheet. Accordingly, when the sheets are saddle stitched and folded in half, a copy of the original booklet shown in FIG. 5 is formed.

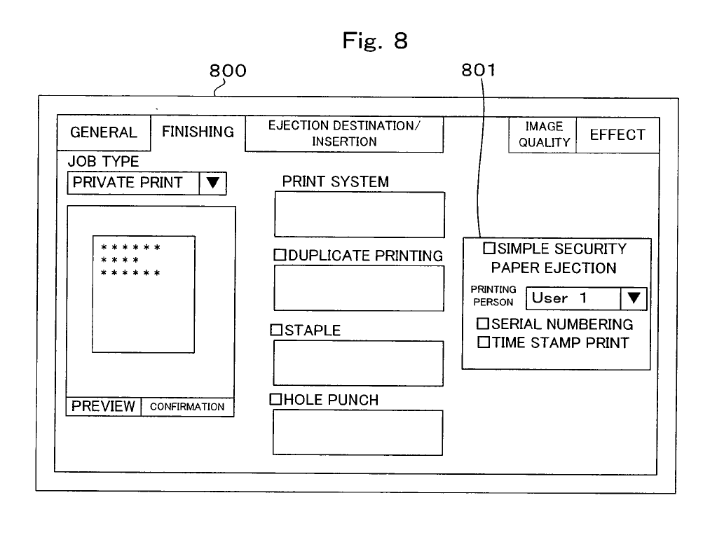

FIG. 8 is a view showing an example of an instruction screen 800 displayed on the control panel 15 of the image forming apparatus 10. In FIG. 8, the details are omitted. As shown in FIG. 8, a simple security paper ejection setting portion 801 is displayed on a specification screen of finishing.

The simple security paper ejection setting portion 801 includes an instruction button as to whether or not simple security paper ejection is set, a pull-down menu to select a previously registered user name, an instruction button to specify serial numbering, an instruction button to specify time stamp printing, and the like.

The image forming apparatus 10 may further include an identifier storage reading portion to store and read information relating to an identifier. The identifier storage reading portion is realized by using the foregoing hardware and software.

The identifier storage reading portion customizes an identifier for each user name and stores it in the storage device. When the user name is selected by the pull-down menu which selects the user name, the information relating to the stored identifier is read out from the storage device by the identifier storage reading portion.

These setting items are stored in the wireless tag 215 for each user, and when each user prints, data stored in the wireless tag reader writer 213 is read, so that the setting items can be set in the image forming apparatus 10. The image forming apparatus 10 prints the identifier based on the read information relating to the identifier.

Besides, the computer 214 may set these setting items in the image forming apparatus 10 by a printer driver installed in the computer 214.

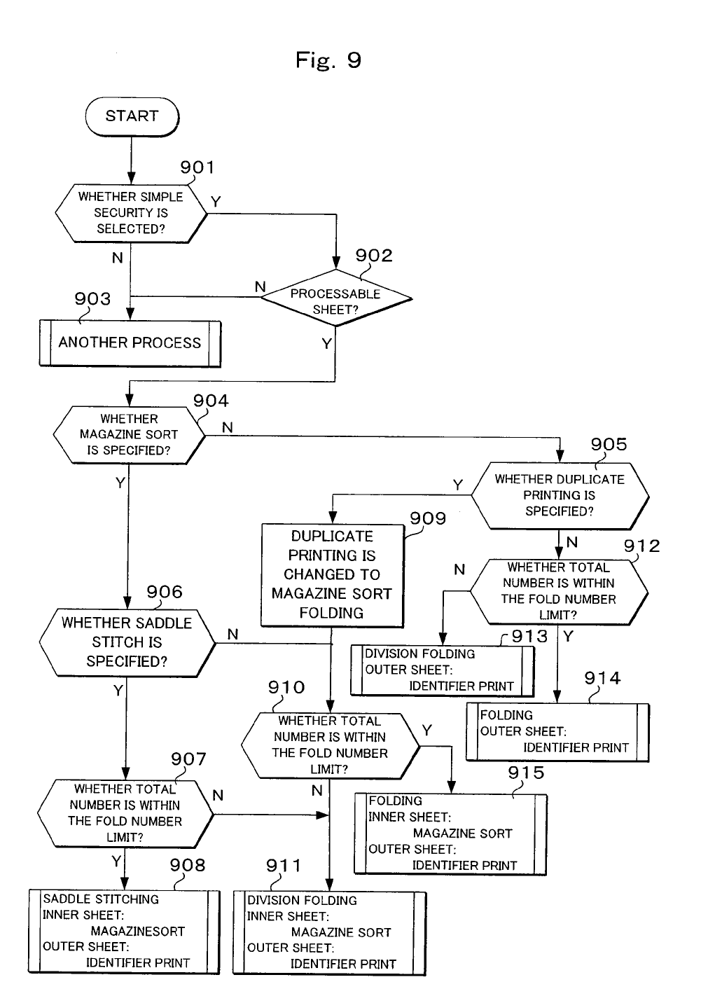

FIG. 9 is a flowchart showing an operation of the image forming apparatus 10. As shown in FIG. 9, at Act 901, the image forming apparatus 10 determines whether the simple security is selected. When the simple security is selected, the image forming apparatus 10 advances to Act 902, and when not selected, the image forming apparatus performs another specified process at Act 903.

At Act 902, the image forming apparatus 10 determines whether the sheet for which printing is specified is such that the simple security paper ejection process can be performed. When the specified sheet is the processable sheet, the image forming apparatus advances to Act 904, and when not processable, it advances to Act 903.

At Act 904, the image forming apparatus 10 determines whether magazine sort is specified. When the magazine sort is specified, the image forming apparatus 10 advances to Act 906, and when not specified, it advances to Act 905.

At Act 905, the image forming apparatus 10 determines whether duplicate printing is specified. When duplicate printing is specified, the image forming apparatus 10 advances to Act 909, and changes the specification of the duplicate printing to the magazine sort and folding, and when the duplicate printing is not specified, it advances to Act 912.

At Act 912, the image forming apparatus 10 determines whether the total number of sheets to be processed is within the limit number of sheets which can be folded. When the total number of sheets to be processed is within the limit number of sheets which can be folded, the image forming apparatus 10 advances to Act 914, and when not within the limit number, it advances to Act 913.

At Act 914, the image forming apparatus 10 prints only the identifier on the outermost recording medium, folds the recording medium and ejects it.

At Act 913, the image forming apparatus 10 performs division folding described later, and prints only the identifier on the outermost recording medium.

At Act 906, the image forming apparatus 10 determines whether saddle stitching is specified. When the saddle stitching is specified, the image forming apparatus 10 advances to Act 907, and when not specified, it advances to Act 910.

At Act 907, the image forming apparatus 10 determines whether the total number of sheets to be processed is within the limit number of sheets which can be folded. When the total number of sheets to be processed is within the limit number of sheets which can be folded, the image forming apparatus 10 advances to Act 908, and when not within the limit number, it advances to Act 911.

At Act 910, the image forming apparatus 10 determines whether the total number of sheets to be processed is within the limit number of sheets which can be folded. When the total number of sheets to be processed is within the limit number of sheets which can be folded, the image forming apparatus 10 advances to Act 915, and when not within the limit number, it advances to Act 911.

At Act 915, the image forming apparatus 10 prints only the identifier on the outermost recording medium, performs magazine sort to the other recording media to perform the image formation, folds all the recording media and ejects them.

At Act 911, the image forming apparatus 10 prints only the identifier on the outermost recording medium, performs the magazine sort to the other recording media to perform image formation, divides and folds all the recording media and ejects them.

At Act 908, the image forming apparatus 10 prints only the identifier on the outermost recording medium, performs magazine sort to the other recording media to perform image formation, folds all the recording media after they are saddle stitched, and ejects them.

Here, the division folding will be described. The division folding is a process in which when the total number of processed sheets exceeds the folding limit number of sheets, the sheets are divided in units of the folding limit number of sheets and folding is performed.

For example, it is assumed that the number of sheets to be subjected to image formation is 18, and the folding limit number of sheets is 5. First, three sheets which are located inside when they are folded are subjected to image formation, are folded and ejected. Next, five sheets which are located outside the three ejected sheets when they are folded are subjected to image formation, are folded and ejected. Finally, only the identifier is printed on the outermost recording medium, and the remaining five sheets are subjected to image formation, are folded and ejected.

As stated above, in the image forming apparatus 10 of this embodiment, the sheet finisher 20 includes the stack tray moving mechanism 54 to move the stack tray 53 by the specified length in the direction of ejection of the recording medium each time the folded recording medium is ejected. The fold line identifier 302 is printed on the surface which becomes the upper surface when the recording medium 300 is folded and ejected, along the fold line and at the position where, when the recording medium is stacked on the stack tray 53, the fold line identifier is not hidden by a subsequently ejected recording medium 300. The printed content is printed on the recording medium which is located inside when folding is performed. Accordingly, since the printing person of the ejected recording medium can be easily specified while the printed content is not known by a person other than the printing person, there is an effect that the security can be simply ensured.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image forming apparatus comprising:
a folding unit to fold a recording medium subjected to image formation;
a stack tray moving mechanism to move a stack tray, on which the folded recording medium is stacked, in a paper ejection direction by a specified length; and
an identifier printing portion to print a fold line identifier on a surface of the recording medium which becomes an upper surface when the recording medium is folded and ejected, along a folded fold line, and at a position where, when the recording medium is stacked on the stack tray, the fold line identifier is not hidden by a subsequently ejected recording medium.

2. The apparatus of claim 1, wherein the identifier printing portion prints a lower identifier on the surface of the recording medium on which the fold line identifier is printed, along a side parallel to a conveyance direction of the recording medium, and at a position where, when a subsequently ejected recording medium is ejected while being shifted in an upper direction, the lower identifier is not hidden by the subsequently ejected recording medium, and prints an upper identifier on the surface of the recording medium on which the fold line identifier is printed, along a side parallel to a conveyance direction of the recording medium, at a position where, when the subsequently ejected recording medium is ejected while being shifted in a down direction, the upper identifier is not hidden by the subsequently ejected recording medium.

3. The apparatus of claim 1, wherein the identifier printing portion performs image formation to locate printed content on an inside surface when the recording medium is folded.

4. The apparatus of claim 1, wherein when image formation of printed content of one sheet is performed on a plurality of sheets, the identifier printing portion prints the identifier only on the recording medium which is located most outside when folding is performed, and
the folding unit collectively folds a plurality of recording media subjected to image formation.

5. The apparatus of claim 1, wherein when image formation of printed content is performed on one side of only one sheet, the identifier printing portion performs the image formation of the printed content on a surface which becomes an inside surface when folding is performed, and prints the identifier on a surface which becomes an outside surface when folding is performed, and
the folding unit folds the recording medium.

6. The apparatus of claim 1, wherein when duplicate printing is performed, the identifier printing portion prints the identifier only on the recording medium which is located most outside when folding is performed, and
printed content is subjected to magazine sort and is subjected to image formation.

7. The apparatus of claim 1, wherein when the total number of processed sheets exceeds the folding limit number of sheets, the folding unit divides the sheets in units of the folding limit number of sheets and folds them.

8. The apparatus of claim 1, further comprising an identifier storage reading portion to store a customized identifier for each user and to read information relating to the stored identifier when the user is selected.

9. The apparatus of claim 1, further comprising a wireless tag reader writer to communicate with a wireless tag, wherein
the wireless tag reader writer reads information relating to the identifier stored in the wireless tag, and
the identifier printing portion prints the identifier based on the read information relating to the identifier.

10. The apparatus of claim 1, wherein the folding unit includes a stapler to staple the recording medium subjected to the image formation, and
when saddle stitching is specified, after the stapler staples the recording medium subjected to the image formation at a folding position, the folding unit folds it.

11. An image forming method of an image forming apparatus comprising:
printing, by an identifier printing portion, a fold line identifier on a surface of a recording medium which becomes an upper surface when the recording medium is folded and ejected, along a folded fold line, and at a position where, when the recording medium is stacked on a stack tray on which a folded recording medium is stacked, the fold line identifier is not hidden by a subsequently ejected recording medium;
folding, by a folding unit, the recording medium subjected to image formation; and
moving, by a stack tray moving mechanism, a stack tray in a paper ejection direction by a specified length.

12. The method of claim 11, wherein the identifier printing portion prints a lower identifier on the surface of the recording medium on which the fold line identifier is printed, along a side parallel to a conveyance direction of the recording medium, and at a position where, when a subsequently ejected recording medium is ejected while being shifted in an upper direction, the lower identifier is not hidden by the subsequently ejected recording medium, and prints an upper identifier on the surface of the recording medium on which the fold line identifier is printed, along a side parallel to a conveyance direction of the recording medium, at a position where, when the subsequently ejected recording medium is ejected while being shifted in a down direction, the upper identifier is not hidden by the subsequently ejected recording medium.

13. The method of claim 11, wherein the identifier printing portion performs image formation to locate printed content on an inside surface when the recording medium is folded.

14. The method of claim 11, wherein when image formation of printed content of one sheet is performed on a plurality of sheets, the identifier printing portion prints the identifier only on the recording medium which is located most outside when folding is performed, and
the folding unit collectively folds a plurality of recording media subjected to image formation.

15. The method of claim 11, wherein when image formation of printed content is performed on one side of only one sheet, the identifier printing portion performs the image formation of the printed content on a surface which becomes an inside surface when folding is performed, and prints the identifier on a surface which becomes an outside surface when folding is performed, and
the folding unit folds the recording medium.

16. The method of claim 11, wherein when duplicate printing is performed, the identifier printing portion prints the identifier only on the recording medium which is located most outside when folding is performed, and
printed content is subjected to magazine sort and is subjected to image formation.

17. The method of claim 11, wherein when the total number of processed sheets exceeds the folding limit number of sheets, the folding unit divides the sheets in units of the folding limit number of sheets and folds them.

18. The method of claim 11, further comprising an identifier storage reading portion to store a customized identifier for each user and to read information relating to the stored identifier when the user is selected.

19. The method of claim 11, wherein
a wireless tag reader writer to communicate with a wireless tag reads information relating to the identifier stored in the wireless tag, and
the identifier printing portion prints the identifier based on the read information relating to the identifier.

20. The method of claim 11, wherein
when saddle stitching is specified, after a stapler staples the recording medium subjected to the image formation at a folding position, the folding unit folds it.
